(19) United States
(12) Patent Application Publication
(10) Pub. No.: US 2014/0137265 A1
(43) Pub. Date: May 15, 2014

(54) System and Method For Securing Critical Data In A Remotely Accessible Database

(71) Applicant: DI Security Corporation, Naples, FL (US)

(72) Inventor: Timothy Haydn Dubman, Chesterfield, MO (US)

(73) Assignee: DI Security Corporation, Naples, FL (US)

(21) Appl. No.: 13/896,833

(22) Filed: May 17, 2013

Related U.S. Application Data
(60) Provisional application No. 61/725,654, filed on Nov. 13, 2012.

(51) Int. Cl. G06F 21/62

(52) U.S. Cl. CPC G06F 21/6245
USPC 726/27

(57) ABSTRACT

A system and method for securing data on data network accessible server including computer implement the steps of receiving user data from a remote application over a write-only data interface, and identifying in the first database a subset of received user data as selectively replicated user data and transmitting the identified selectively replicated user data over a secured data interface. The method also includes receiving the transmitted selectively replicated user data over a communicatively coupled second secured data interface and storing the received selectively replicated user data in a transactional database. The method further includes receiving a request for requested user data from a remote application at the transactional database over a read-only data interface and transmitting at least a portion of the stored selectively replicated user data as the requested user data responsive to the received request.

### CROSS-REFERENCE TO RELATED APPLICATIONS

This application claims the benefit of U.S. Provisional Application No. 61/725,654, filed on Nov. 13, 2012, the disclosure of which is incorporated herein by reference.

### FIELD

The present disclosure relates to data processing systems and, more specifically, to public and private remotely accessible data processing systems having secured customer data.

### BACKGROUND

The statements in this section merely provide background information related to the present disclosure and may not constitute prior art.

As recently reported, since 2004 over one billion records containing consumer's critical data have been compromised via Internet connected systems. See 2012 Verizon Data Breach Investigations Report, http://www.verizonbusiness.com/resources/reports/rp_data-breach-investigations-report-2012_en_xg.pdf. In 2011 the cost to an organization losing data was $194 per lost record, and Barclays projects the annual cost of identity theft in Britain alone being over £2.7 billion. A principal attack vector utilized to obtain database records containing critical data is called SQL injection, with the head of payment security at Barclaycard claiming the method is responsible for 97 percent of data breaches.

SQL Injection is an attack method introduced by the coding practices of web developers that allows hacker code to be executed by a backend database through a web application. As attacks are usually dependent upon the developer code being written, and not the vendor supplied code in the form of the operating system, database management system, or application server, it is quite prevalent. While solutions such as database centric firewall and encryption solutions have been introduced to secure the critical data, they ultimately fail as the web application still has direct access to the critical data.

Today database centric firewalls exist and attempt to protect critical data from hackers and improper and often illegal attempts to gain access to critical private user data, so far there are no foolproof ways of doing such as is evident by over a billion records being lost to hackers each year. In promoting their database firewall, software companies such as Oracle state that they have implemented privileged user controls inside the databases that are aimed at playing an important part in securing applications, however, even these companies admit that user data is not completely secure and protected from hackers such as those utilizing SQL injection attacks. See Oracle Databases Firewall, at http://www.oracle.com/technetwork/database/security/ovw-oracle-database-firewall-1447166.pdf (Oracle states in promoting their database firewall, “ . . . solutions such as encryption and privileged user controls inside the database play an important part in securing applications . . . however [they] do not protect against SQL injection attacks . . . ”).

The inventor hereof has determined that Oracle and other database software companies' methods of using privileged user controls are likely to be inadequate to completely protect critical user data from hacker attacks such as SQL injection. As such, the inventor hereof has identified the need and developed a novel nonobvious system and method that is a fundamentally different approach that used by database companies such as Oracle to protect web accessible critical user data. The inventor has identified a need for improved protection of critical data stored in internet connection or private network databases and in particular the protection of consumer critical data from hackers using hacking techniques such as SQL injection attacks while still enabling the operational and transactional access to transactional user data by valid web applications.

### SUMMARY

The inventor hereof has succeeded at designing a system and method for protection of critical data such as credit card numbers or social security numbers by implementation of a “layer” that takes the burden of critical data protection away from the web developer. The inventor has created a novel solution that utilizes an approach that plays upon the strength of segregated privileged user controls and the replication of noncritical data in a unidirectional fashion. As will be described, the system and method disclosed herein does not focus on the traditional privileges of user controls but rather focuses on the concept of “least privilege,” and takes the security and protection burden off of the web developer who typically introduces vulnerabilities such as SQL injection into the application. This is accomplished by implementing multiple accounts in the application that have access to specific databases, one account with READ access and the second account with WRITE access. As the web application only writes to a first database, and only reads from a transactional database containing partially replicated data, the critical data is effectively secured.

The system and method herein focuses upon a method that plays upon the strengths of segregated privilege user controls and the replication of non-critical data and removes direct data access. This is an approach that is completely different and not addressed or developed by database vendors such as Oracle who have focused their attention and development efforts on database firewalls, encryption, and privileged user controls inside the database.

According to a first aspect, a system for securing data on data network accessible server including a secure data application including a first database and a first data interface for receiving user data and storing the received user data, the application configured for identifying a subset of received user data as selectively replicated user data, and a secured database interface for providing the identified selectively replicated user data to a transactional database. The system also includes the transactional database having a secured database interface communicatively coupled to the secured database interface of the secure data application and receiving the selectively replicated user data, storing the received selectively replicated user data, the transactional database having a data request interface for receiving a request to provide requested user data, the transactional database configured to provide at least a portion of the stored selectively replicated user data in response as the requested user data in response to the request thereof.

According to one aspect, a system for securing data on data network accessible server including a first database server, a transactional database server and an application server. The first database server has a data network accessible interface configured for receiving user data, storing the received user data, and identifying a subset of received user data to be provided as selectively replicated user data, and a secured database interface for providing the identified subset of the received user data as selectively replicated user data. The transactional database server has a secured database interface communicatively coupled to the secured database interface of the first database server and receiving the selectively replicated user data, storing the received selectively replicated user data, and a data network accessible interface for receiving a request to provide requested user data and providing provided user data that includes at least a portion of the stored selectively replicated user data. The application server is configured for receiving user data from a user, receiving the user data over the user application interface, transmitting the receiver user data over the database server interface to the first database server, receiving a request for the certain user data, transmitting the request for user data to the transactional database server, receiving from the transactional database server the provided user data, and providing the provided user data as received from the transactional database server.

According to another aspect, a system for securing data on data network accessible server, the system including a first database server having a processor, a memory, a data network accessible interface configured for receiving user data, having computer executable instructions for a write only database for storing the received user data and identifying a subset of received user data to be provided as selectively replicated user data, and a secured database interface for providing the identified subset of the received user data as selectively replicated user data. The system includes a transactional database server having a processor, a secured database interface communicatively coupled to the secured database interface of the first database server and receiving the selectively replicated user data, a memory for storing the received selectively replicated user data, and a data network accessible interface configured for receiving a request to provide requested user data and providing provided user data that includes at least a portion of the stored selectively replicated user data. The system also includes an application server having a processor, memory, a user application interface for receiving user data from a user, a third party application interface for receiving a request for certain user data, and a database server interface communicatively coupled to the data network accessible interface of the first database server and the data network accessible interface of the transactional database server, the application server configured with computer executable instructions receiving the user data over the user application interface, transmitting the receiver user data over the database server interface to the first database server, receiving a third party request for the certain user data over the third party application interface, transmitting the request to provide requested user data to the transactional database server for the certain user data over the database server interface to the transactional database server, receiving from the transactional database server the provided user data, and providing over the third party application interface a response to the third party request that includes the received provided user data.

In yet another aspect, a method for securing data on data network accessible server, the method including the steps of receiving user data from a remote application over a write-only data interface and storing the received user data in a first database. The method includes identifying in the first database a subset of received user data as selectively replicated user data and transmitting the identified selectively replicated user data over a secured data interface. The method also includes receiving the transmitted selectively replicated user data over a communicatively coupled second secured data interface and storing the received selectively replicated user data in a transactional database. The method further includes receiving a request for requested user data from a remote application at the transactional database over a read-only data interface and transmitting at least a portion of the stored selectively replicated user data as the requested user data responsive to the received request.

According to yet another aspect, a method for securing data on data network accessible server, the method including the steps of: receiving user data in a first database from an remote application, storing the received user data, identifying a subset of received user data as selectively replicated user data, and transmitting the selectively replicated user data to a transactional database; receiving in the transactional database the selectively replicated user data, storing the received selectively replicated user data, transmitting a request from the remote application to the transactional database for transactional user data; receiving the request for requested user data from the remote application by the transactional database; and providing at least a portion of the stored selectively replicated user data as the requested user data to the remote application responsive to the received request.

According to still another aspect, a method for securing data on data network accessible server, the method including the steps of: a) in an application server, receiving user data from a user over a user application interface, and transmitting the received user data to a first database server; b) in the first database server, receiving user data from the application server, storing the received user data, identifying a subset of received user data as selectively replicated user data, and transmitting the selectively replicated user data to a transactional database server; c) in the transactional database server, receiving the selectively replicated user data, storing the received selectively replicated user data, d) in the application server, receiving a request to provide requested user data from an application server; and transmitting to the transactional database server a request for user data; e) in the transactional database server, receiving the request for user data from the application server; and providing at least a portion of the stored selectively replicated user data to the application server as provided user data; and f) in the application server, receiving the provided user data from the transactional database server; and providing the provided user data as received from the transactional database server to the application server responsive to the request for requested user data.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a simplified schematic drawing of a system for securing critical data in a remote accessible database according to one exemplary embodiment.

FIG. 2 is a block diagram of a system wherein the user data is provided by a first application or application server and the transactional application requesting the user data is in a separate server according to another exemplary embodiment.

FIG. 3 is a block diagram of another embodiment of the system.

FIG. 4 is a data diagram of the user data elements in the secured database as compared to the second remotely accessible database.

FIG. 5 is a flow chart illustrating one method of securing critical user data for use in transactional processing according to one exemplary embodiment.

FIG. 6 is a flow chart illustrating a second method of securing critical user data for use in transactional processing according to one exemplary embodiment.

FIG. 7 is a block diagram of a computer system suitable for use with a secure database system and method according to one exemplary embodiment.

FIG. 8 is a block diagram of a system according to another exemplary embodiment.

It should be understood that throughout the drawings and specification references thereto, corresponding reference numerals indicate like, similar, or corresponding, but necessarily identical parts and features.

### DETAILED DESCRIPTION

The following description is merely exemplary in nature and is not intended to limit the present disclosure or the disclosure's applications or uses.

Before referring to the exemplary embodiments shown in the accompanying figures, the systems and methods of the present disclosure will be described. After which, several exemplary embodiments will be described with reference to the accompanying Figures by way of example, wherein the scope of the present disclosure is not limited to those exemplary embodiments and is not intended to limit the present disclosure or the disclosure's applications or uses or the scope of the claims. As will be known to one of skill in the art after reviewing this disclosure, all references to a database is for explanation purposes and should be considered to include various embodiments of memory database systems, servers, and methods related thereto including redundant systems, clusters, farms or cloud service. These are often referred generically herein as servers, database servers or simply databases, unless otherwise indicated.

According to one exemplary embodiment, a system for securing data on data network accessible server including a secure data application including a first database and a first data interface for receiving user data and storing the received user data. In some embodiments, the data interface of the secure data application first database is configured as a write-only interface and is configured to not provide a response or provide any data responsive to any data read requests. The secure data application is configured for identifying a subset of received user data as selectively replicated user data. This secure data application can store the entire contents of the received user data. The secure data application and database also includes a secured database interface for providing the identified selectively replicated user data to a transactional database.

The system also includes the transactional database having a secured database interface communicatively coupled to the secured database interface of the secure data application and receiving the selectively replicated user data. The transactional database stores the received selectively replicated user data. The transactional database has a data request interface for receiving a request to provide requested user data. The transactional database is configured to provide at least a portion of the stored selectively replicated user data in response as the requested user data in response to the request thereof. The transactional database and the data interface of the transactional database can be configured as a read-only interface and is configured to not respond to any data write requests but only provide at least a portion of the stored selectively replicated user data.

This system can be communicatively coupled, such as over a public, private, open, secure or semi-secure, data network, such as the internet or intranet or use of IP tunneling, to an application such as a transactional application hosted on a separate computer or server remote from the above databases. These one or more transactional applications are configured for receiving user data from a user over a user application interface and transmitting the receiver user data over a first database interface to the secure database application.

These can be the same or different transactional applications on the same or different servers are also configured for receiving a request that includes the certain user data. This can typically be a request for processing a later user transaction over a web page or other internet connection, such as a payment request for payment of a particular product or service or the like. This second transactional application transmits a request for certain user data to the transactional database such as a request for validation of the user credit or debit information or verification of certain user data for comparing or processing within a transactional application. This transactional request for certain user data is not transmitted to the secure database, but is only transmitted to the transactional database. As such, the first and second transactional applications are a single transactional application, such is configured or programmed to provide the full secure and transactional available user data to the secure database application but to not query that same database application but rather to only send requests for transactional processing to the transactional database. The request is received by the transactional database and the transactional database is configured to prepare a response to the request to provide the requested data but only as available within the transactional database.

The transactional database transmits the requested data from the transactional database with the provided certain user data which is received by the transactional application responsive to its request. The data provided by the transactional database is only data that is available in the transactional database and therefore, may or may not be completely all of the data requested by the transactional application. However, the transactional database can only provide the data that is stored therein, and that is only the selectively replicated user data as provided by the secure database over the secured database interface coupling the transactional database to the secure database. As such, the transactional application can only obtain that data which is selectively replicated and wherein such selectively replicated data does not contain any critical user data, the transactional application cannot obtain access to critical user data.

As noted the transactional application can be a computer implemented application on a transaction processing system for processing user related transactions. As such, the transaction processing system is typically communicatively coupled to the secure database application over a public or private data network. In some embodiments, the transactional application includes a user interface (such as a hosted web-based user interface) for receiving the user data from the user. Of course, this could also be a data interface for receiving a data stream from another application hosting a separate user interface or graphical user interface such as a web page or portal. One example of this is an interface between a web based shopping system and a click-to-buy checkout payment service such as PayPal™. As another example, a hosted web-based user interface receives user data including first user data and second user data. The first user data can be non-critical user data and the second user data can be or include critical user data. In such embodiments, the non-critical user data can be data such as user or account holder identification, name, application, transactional name, and identification and the second or critical user data can include the user's social security number, one or more financial or other account numbers, a credit card number, a personal identification number (PIN) associated with one of the user's accounts, a password, and security code such as the three digit security code on the back of the credit card or a separate financial account access security code, security verification phrases and replies. These are all by way of example and are not to be considered as limited in any manner.

It should also be noted that the secure database or secure database application may also obtain user data from another secure data source and associate such secure user data with the user provided data. For instance, the secure database application may be a financial transaction application for a financial institution and the financial institution may assign or associate account codes or other data with the user provided data to create the entire set of user data in the secure or first database application and server.

In some embodiments, the system and method of the secure database are configured to receive both the first and second user data, and then identify from such first and second user data a subset thereof of each of the first use data and second user data. In some embodiments, all of the first user data is selectively provided to the transactional database, but in other embodiments less than all of the first user data is provided. Generally, the selectively replicated user data does not include the full contents of the second user data. For instances, the selectively replicated user data can include a selected subset of the second user data, such as the last few digits (for example last four digits) of a social security number or a credit card, by way of example. In other words, the selection criteria or algorithm for identifying the selectively replicated data from the secured user data would not include the entire numbers, or portions that can be backward determined from the selectively replicated data, but rather is derived secured data that is derived from a portion of the second user data (such as an encryption of a password, or the like, but not the password or secured data itself. In other embodiments, the selectively replicated user data excludes a full social security number, a full credit card number, a card security CVV code, a full pin number, or a full user account number, but can include a full social security number, a full credit card number, a card security CVV code, a full pin number, or a full user account number.

As noted, the secure data application and the transactional database can be implemented on separate servers having separate processors or processing systems, with separate or shared memory systems, data network accessible interfaces and communicatively coupled secured database interfaces or can be implemented on the same database server as such and various other hardware implementations of the systems and methods described herein are considered to be within the scope of the present disclosure. These can be various physical embodiments or virtual systems providing similar functionality.

According to another exemplary embodiment, a system for securing data on data network accessible server including a first database server, a transactional database server and an application server. The first database server has a data network accessible interface configured for receiving user data, storing the received user data and identifying a subset of received user data to be provided as selectively replicated user data. The first database server has a secured database interface for providing the identified subset of the received user data as selectively replicated user data. In some embodiments, the first database server and/or the data network accessible interface of the first database server is configured as a write-only interface and is configured to not respond to any data read requests from the application server over the first database server data network accessible interface.

The transactional database server has a secured database interface communicatively coupled to the secured database interface of the first database server for receiving the selectively replicated user data. The transactional database server stores the received selectively replicated user data. The transactional database server also has a data network accessible interface (such as via the Internet by way of example) for receiving a request to provide requested user data. The transactional database server provides provided user data in response to the request over the data network accessible interface with such provided user data including at least a portion of the stored selectively replicated user data. In some embodiments, the transactional database server and/or the data network accessible interface of the transactional database server is configured as a read-only interface and is configured to not respond to any data write requests from the application server over the first database server data network accessible interface.

The application server is configured for receiving user data from a user, receiving the user data over the user application interface, transmitting the receiver user data over the database server interface to the first database server, receiving a request for the certain user data, transmitting the request for user data to the transactional database server, receiving from the transactional database server the provided user data, and providing the provided user data as received from the transactional database server.

As noted above, each of the first database server and the transactional database server can be can be implemented in any physical, logical or virtual manner and are not intended to be limited to particular implementations or implemented technology.

According to yet another exemplary embodiment, a system for securing data on data network accessible server, the system includes a first database server having a processor, a memory, and a data network accessible interface configured for receiving user data. The first database server has computer executable instructions for a write only database for storing the received user data and identifying a subset of received user data to be provided as selectively replicated user data. The first database server can have a secured database interface for providing the identified subset of the received user data as selectively replicated user data. In some embodiments, the first database server and/or the data network accessible interface of the first database server is configured as a write-only interface and is configured to not respond to any data read requests from the application server over the first database server data network accessible interface.

The system includes a transactional database server having a processor, a secured database interface communicatively coupled to the secured database interface of the first database server for receiving the selectively replicated user data therefrom. It also has a memory for storing the received selectively replicated user data. The transactional database server includes a data network accessible interface for receiving a request to provide requested user data. In some embodiments, the transactional database server and/or the data network accessible interface of the transactional database server is configured as a read-only interface and is configured to not respond to any data write requests from the application server over the first database server data network accessible interface. The transactional database server reviews the request and determines the appropriate response of user data as stored within the transactional database memory and prepares a response to the request. The transactional database server transmits or otherwise provides the determined provided user data that includes at least a portion of the stored selectively replicated user data over the data network accessible interface responsive to the received request.

The system also includes an application server having a processor, memory, a user application interface for receiving user data from a user, and a third party application interface for receiving a request for certain user data. The application server can be any computer system with an application for retrieving user data and in some embodiments includes a web hosting server such that the third party application is a hosted web application thereon. However, it should be understood that this system and method are not limited to such web hosted embodiments.

A database server interface is communicatively coupled to the data network accessible interface of the first database server and the data network accessible interface of the transactional database server. The application server has computer executable instructions configuring the server for receiving the user data over the user application interface and transmitting the receiver user data over the database server interface to the first database server. The application server can also include configuration for receiving a third party request for the certain user data over the third party application interface and transmitting the request to provide requested user data to the transactional database server for the certain user data over the database server interface to the transactional database server. The application server then waits for a response and receives from the transactional database server the provided user data and then provides over the third party application interface a response to the third party request that includes the received provided user data.

As noted above, in some embodiments, the user interface is a graphical user interface, web application, mobile application, or hosted application. For example, a user accessing a web or mobile application is prompted to provide user data and such input data becomes received user data at the first database that includes both first user data which is non-critical user data (see above) and second user data which is critical user data (as also described above). In some embodiments, all or a portion of the first user data and/or second user data is received from remote or separate application such as a secure application from a secured party. This can be a third party application such as a bank or other financial institution including a payment or credit entity. For instance, the provided and received data can include an assignment or association of one or more PIN numbers, passwords, security codes or phrases, and account numbers, by way of example.

In some embodiments a secured application associated with the first database or within the programming of the first database is configured via software instructions to identify a subset of the received and stored user data. This identified subset of received and stored (in the first database) user data can include all or a portion of the first user data and at least one of a selected subset of the second user data and derived secured data derived from a portion of the second user data. This identified subset of user data can include, but is not limited to, second user data or derived secured data derived from a portion of the second user data. For example, this can be only the last four digits of a social security number, a credit card number, or passcode, e.g., a subset of the second user data input by the user and received by the first database. The selectively replicated user data can include any data as may be programmed by the secured application programming or algorithm or selection by the user or a third party such as a financial institution. The secured application can include programming wherein the identifying excludes data such as all or a portion of the social security number, the credit card number, a card security CVV code, a pin number, and a user account number, by ways of example, as these are only examples of critical data that is associated with the user data, that are only stored in the secured database, and are not accessible in the remotely accessible transactional database server. Data items that may be included in the selectively replicated user data can include a subset of the full social security number, the full credit card number, the card security CVV code, the full pin number, and the full user account number, as well as the user name, account number or the like, or a derivation therefrom. Other examples are described above. The identification of which data is provided to the transactional database and therefor remotely accessible can be defined by the system administrator based on the particular needs of the transaction processing system.

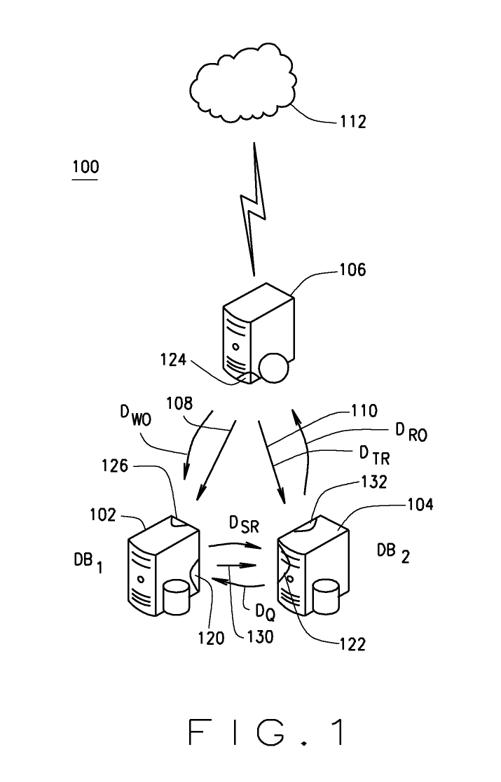

Referring to FIG. 1 is a schematic of a system 100 for securing critical data in a remote accessible database according to one exemplary embodiment. As shown, system 100 includes a secured database 102 having a data interface 126 that is shown coupled to web application server 106 having data interface 124 and communicating over a write-only logical communication data link 108. The web application server 106 provides the initial user data D_{WO} that is received and stored in the secured database 102. As will be should be understood, the secured database 102 can be any suitable data storage system as described above and is shown in FIG. 1 as a single server database only for simplistic illustration. Similarly, while the data origination system is illustrated as a web application server 106, such is only by way of example and other systems and applications for originating the write only communication with the secured database 106 are also considered within the scope of the present disclosure. Further, the write-only logical communication link 108 which provides the communication data interface 124 of the web server 106 and the data interface 126 of the secured database 102 can be any suitable communication system using any suitable communication protocol. While the data provided by web server 106 to the secured database 102 is described herein as being write-only D_{WO}, it should be understood that in implementation, that each of the write-only logical communication link 108, the communication data interface 124 and the data interface 126 typically implement and support communications protocols that provide two-way or duplex communication messaging and the indication herein is that such duplex communication messaging and protocols support the write-only data function of the user data from the web server 106 and the secured database 102.

In some embodiments, additional secure user data can be provided to secured database 102 by other means not shown in FIG. 1, such as via an auxiliary or backend/back office system. The web application server 106, as shown in this example, can be communicatively coupled to the Internet 112. In this example, a web application is hosted on the web application server 106 to enable a user or another application to prompt or collect user data and then to provide the user data that is to be written to the secured database 102 as the write only D_{WO} data.

The secured database 102 also includes a secure data interface 120 that is securely communicatively coupled via data link 130 to a transactional database 104 having a secure data interface 122. The data link 130 can be implemented as a write only data interface as well or can be a secure IP tunnel or other suitable communication link. It should be understood to those of ordinary skill in the art that the reference to a read only interface 122 refers to the handling of the data, and does not relate to the communication protocol itself, as the protocol for the read only interface 122 could be a duplex interface with acknowledgments, error correction and detection, and encryption, or can in some embodiments be a datagram messaging format.

The secured database 102 is configured to determine a subset of the received and stored user data (e.g., D_{WO}) that will be provided as selectively duplicated data D_{SR} to the transactional database 104 over secure data interface 120 to the transactional database secure data interface 122 over data link 130. Typically the programming within the secured database 102 defines the criteria by which the selectively replicated user data D_{SR} is identified from the stored user data D_{WO}. As further shown in this example, the same web application 106 is configured to originate a request for user data from the transactional database 104 over second communication data link 110. However, web application server 106 does not send the read only request D_{RO} for user data to the secured database 102 as its logical interface to the secured database 102 is only a write only interface. Rather, the web application server 106 transmits any and all requests for user data to the transactional database 104 over the second data interface 124 to the read-only interface 132 of second/transactional database 104. As will be understood, while the second data interface 124 of the web application server 106 is described and shown as the same interface as communicates with the secured database 102, such is only for description purposes and second data interface 124 could be implemented as a separate data interface or could be implemented on a separate and distinct web application server 106. The transactional database 104 receives the read only request D_{RO} for user data via second data communication link 110 and identifies the requested user data D_{RO} associated with the request from the stored D_{SR} as previously provided via data link 130 from the secured database 126. The transactional database 104 prepares a reply containing the requested user data D_{RO} via the read only interface 132 back to web application server 106. As described, in some embodiments the transactional database 104 receives the selectively replicated data D_{SR} as push data from the secured database 102.

However, in other embodiments, the write only data D_{WO} is stored in the secured database 102 and does not provide all or a particular selectively duplicated data D_{SR} to the transactional database 104 until a request from the transactional database 104 for such D_{SR} is received. In such embodiments, the transactional database 104 receives a read only data request D_{TR} from the web application server 106 and determines that it does not currently have the requested read only data D_{RO} stored and has not received such as push data from secured database 102. As such, the transactional database 104 queries the secured database 102 to request that the secured database 102 provide the selectively duplicated data D_{SR} to the transactional database 104. In such embodiments, the secured database 102 receives the request over data link 130, selects the selectively duplicated data D_{SR} and transmits such to the transactional database 104 over the data link 130. The transactional database 140 then either uses the received selectively duplicated data D_{SR} to prepare the read only data D_{RO} and/or stores the selectively duplicated data D_{SR} and responds with the read only data D_{RO} as provided in the received selectively duplicated data D_{SR}. As noted, in one embodiment the transactional database 104 does not contain the particular selectively duplicated data D_{SR} as associated with a particular user or user account related to a received request for transaction data D_{TR}. The transactional database 104, in the absence of then having the necessary data D_{SR} sufficient to respond to the data request D_{TR}, can initiate a query to the secured database 104 to obtain the required selectively duplicate data D_{SR}. The first database 102 receives the data query D_{Q}, and identifies the associated secured data and then process that data or pulls such from its memory that selectively duplicated data D_{SR} and transmits that to the transactional database 104. Once received by the transactional database 104, the transactional database 104 responds to the data request D_{TR} with such D_{SR}.

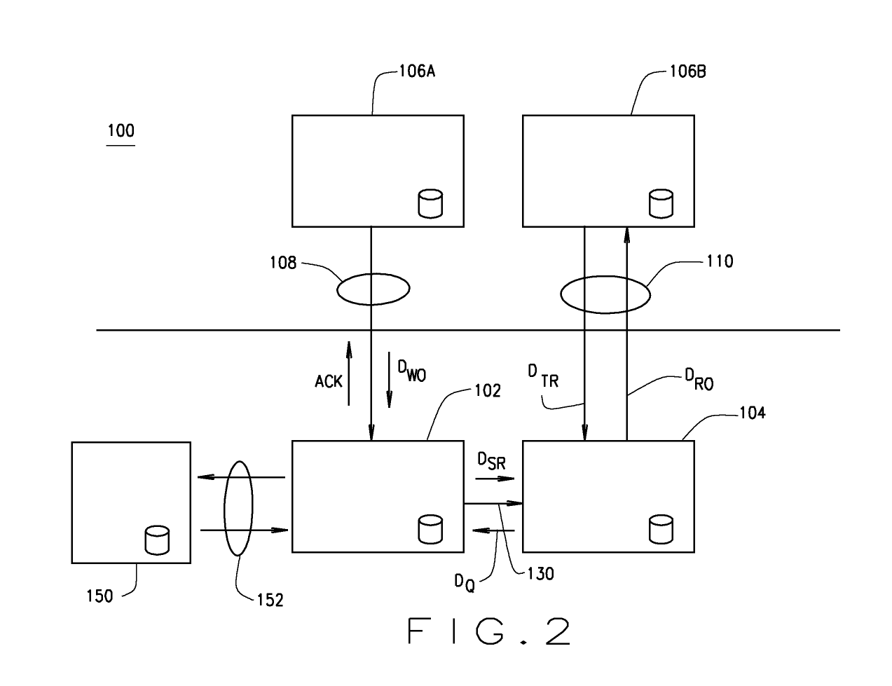

In FIG. 2 is another embodiment of system 100 is shown where the user data D_{WO} is provided by a first application or application server 106A and the transactional application requesting the user data D_{RO} is in a separate transactional application server 106B. This embodiment of system 100 is similar to that of FIG. 1 otherwise, except that in this embodiment, the communication links 108 and 110 are at least logically separate, though they may be physically the same. Further, as addressed, the first application 106A and the transactional application 106B can be configured in any manner and while shown as being implemented on separate servers, can be implement on a single server or a plurality of different servers and still be within the scope of this disclosure. The transactional server 106B prepares a transaction request for data D_{TR} that is sent to the transactional database 104 for transaction processing. Also this embodiment illustrates a secure application server 150 that is securely coupled to the secured database/database server 102 via secure interface 152. As previously noted, the logic which identifies which data information from the complete secured user data D_{WO} that is stored in the secured database 102 can be implemented within the secured database or as in this embodiment, can be implemented by application software or a separate application server 150 that accesses the secured database 102. Server 150 could provide some or all of the user data stored in secured database server 102 rather than receiving such from user data application 106A. Server 150 could be an application or server such as provided by a back office financial institution which is responsible for securing the user data and/or for processing of the selective replication for subsequent delivery as D_{SR} for transactional processing by transactional database 104.

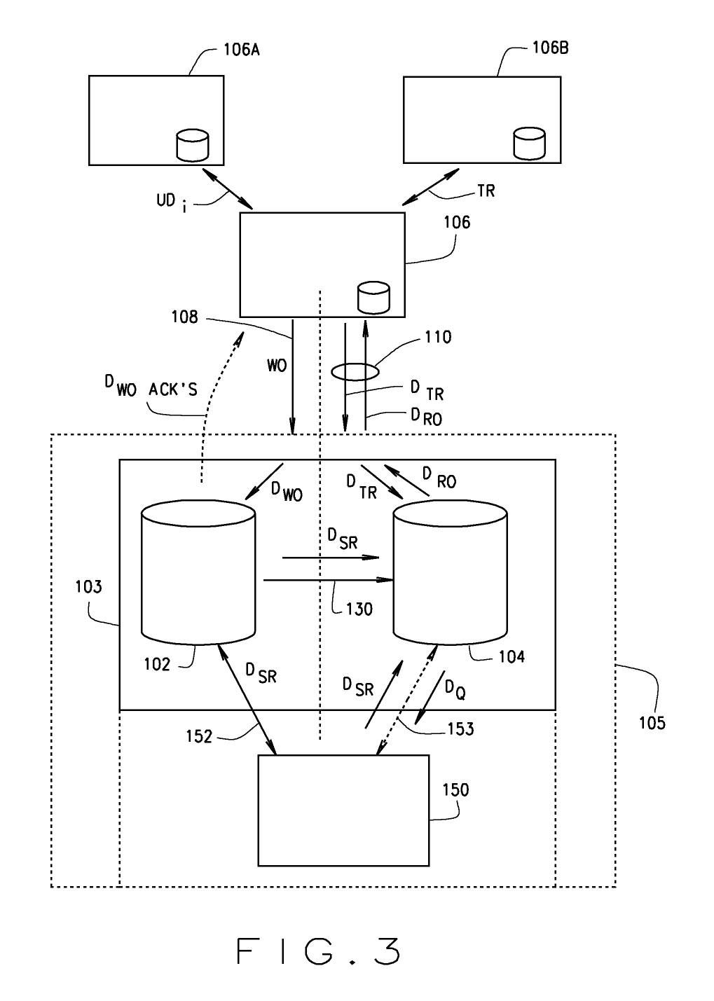

FIG. 3 illustrates another embodiment of system 100 wherein the secured database 102 and transactional database 104 are implemented in a single server system 105 or configuration and within a secure environment with the secure application server 150. As shown, the first application 106A includes a user interface that receives and provides user data input UDᵢ to an application system 106. The application system 106 prepares the user data that is to be write-only data D_{WO} for the secured database 102. The application system 106 can base this solely on the user data input UDᵢ as received from the user interface of the first application 106A, or can add additional application data to the UDᵢ such as security and related transactional system or entity data. The secured database 102 can provide an acknowledgement message ACK to first application 106 via data link 108 verifying receipt of D_{WO}. In this illustrative embodiment, the secure application server 150 provides the secured database 102 with instructions over data link 152 for enabling the secured database 102 to identify and/or create the selectively duplicated date D_{SR} from the received data D_{WO} and for providing the D_{SR} to the second data base 104. This can either be directly via data link 130 or via secure application server 150 via data link 153. Typically at a later time, the user or an entity uses a second application server such as a transactional server 106B that initiates a transaction T_{R}, such as a request for a payment for a transaction, by way of example. The transaction server 106B communicates the transaction T_{R} to the first application 106 which is typically a local transaction system or application system 106 supporting a plurality of transactional servers 106B. While the application system 106 is shown as being the same system as processing the user data input UDᵢ, in other embodiments it may a different system or application. The application system 106 prepares a transaction data request D_{TR} and transmits such over data link 110 to the transactional database 104. The secured database 102 is configured to not respond to any requests for any data over data link 110 or provide any of its received and stored data D_{WO} in response to any transaction data requests D_{TR}.

The transactional database 104 receives that transaction data request D_{TR} and identifies the associated or required selectively duplicated data D_{SR} which is typically associated with the particular user account of the transaction request T_{R} that initiated the transaction data request D_{TR}. The transactional database 104 provides the D_{SR} as read only data D_{RO} in response to the D_{TR}. The data link 110 can also provide acknowledgements. However, the transactional database 104 is communicatively configured as a read only database with respect to application server 106 and does not accept or respond to any attempts to write data to the transactional database 104 over data link 110. Transactional database 104 is configured to only receive and store selectively duplicated data D_{SR}. The D_{SR} data that is stored by the transactional database 104 can be monitored and reviewed by a secure application server 150 to ensure that the transactional database 104 does not contain any customer data that does not comply with the selectively secured data instructions. As noted above, the secure application server 150 can also coordinate between the transactional database 104 and the secured database 102 if particular user data is not then resident in the transactional database 104. As shown in FIG. 3, the transactional database 104 can initiate a query D_{Q} to the secure application server 150 or to the secured database 102 in the situations where the transactional database 104 does not have the selectively duplicated data D_{SR} necessary for responding to a particular read only data request D_{RO}. Such D_{SR} can be prepared by either the secured database 102 or the secured application server 150 and provided to the transactional database 104 for preparing the read only data D_{RO} that is then sent to the application server 106.

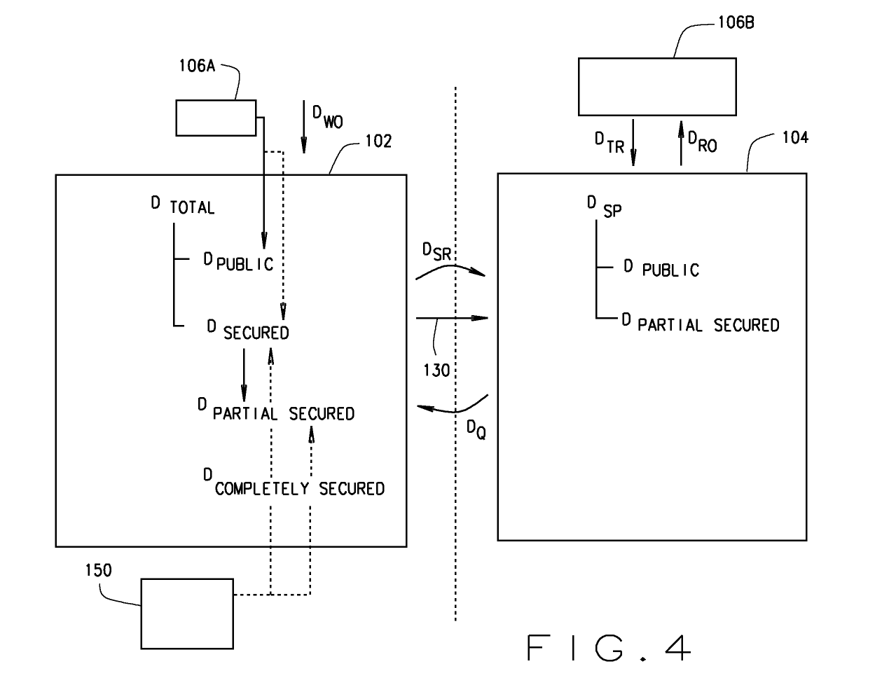

As shown herein FIG. 4 illustrates a compilation of the data structures within secured database 102 and the transactional database 104. As shown the first application server 106A can provide the secured database 102 with the write only data D_{WO} which can comprise the total amount of user data UD_{TOT}. The UD_{TOT} can include public data D_{PUB} and secured data D_{SD}. The secured data D_{SD} can also compose both partially secured data D_{PS} and completely secured data D_{CS}. In contrast, the second database 104 that includes interface 132 to transactional application 106B and that receives data requests D_{TR} therefrom, receives the selectively duplicated/replicated data D_{SR} from the secured database (first database) 102 and stores the D_{SR} therein. The D_{SR} as stored by the second database 104 can include public data D_{PUB} as well as partially secured data D_{PS}, each of which is based on the received selectively replicated/duplicated data D_{SR}.

### Methods of Operation

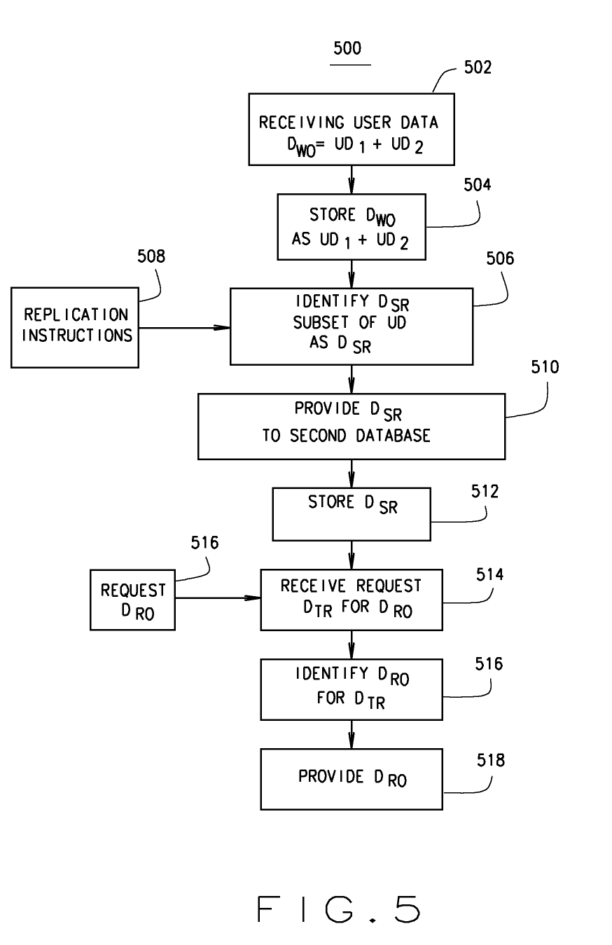

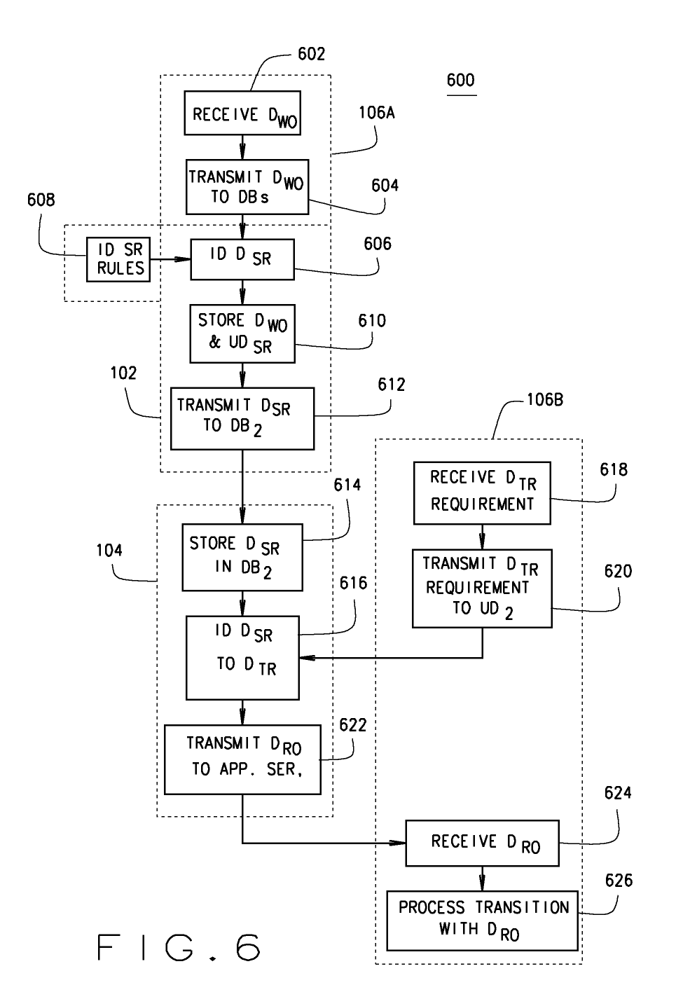

According to several exemplary embodiments of method of operating a secure data accessing system as described above are illustrated in FIGS. 5 and 6 by way of examples. As shown in FIG. 5, a method 500 for securing data on data network accessible server starts at process 502 receiving user data UD₁ (which could be the received user input data UDᵢ) and/or UD₂ (which could be system supplied data). These are combined in process 502 to form write only data D_{WO}. These are received from a remote application 106 over a write-only data interface 108 and stored in a first/secured database 102 in process 504. Next in process 506 performed by first database 102, a subset of the received user data D_{WO} is selectively replicated/duplicated as user data D_{SR} based on a set of replication or duplications instructions provided by process 508, which could be within the database 102 or within a secured application 150. The selectively replicated data DSR is provided or transmitted over a secured data interface 130 to a second database 104 in process 510. The method also includes the receiving of the transmitted selectively replicated user data D_{SR} over a communicatively coupled second secured data interface 130 at the second database 104 in process 512 wherein it is stored therein, which in this embodiment second database 104 is shown as a transactional database 104 by way of example. The method further includes process 514 receiving a request for user data D_{TR} which in this example is a transactional data request D_{TR} such a for processing or authorizing a payments from a remote application at the transactional database over a read-only data interface. In process 516 performed in the second database 104, the method includes identifying the related or associated stored user data D_{SR} responsive to the request for data D_{TR}. The read only data D_{RO} is provided or otherwise transmitted in process 518 to the application server 106 via data link 110 with the read only data D_{RO} being derived from the stored selectively replicated data D_{SR}. This could be at least a portion of the stored selectively replicated data D_{SR} associated with the requested user data D_{TR} as necessary to be responsive to the received request D_{TR}.

Referring now to FIG. 6, method 600 provides for securing data on data network accessible server according to another embodiment. Process 602 provides for receiving user data D_{WO} such as UDᵢ in a first database 102 from a remote application/application server 106 and transmitting and then storing the received user data D_{WO} therein in process 604. A subset of the received user data D_{WO} is identified as selectively replicated user data D_{SR} in process 606 based on selectively replicated identification rules as provided by process 608, which may be programming or parameters as defined in secured database 102 or in a secure application 150 coupled thereto. This selectively replicated user data D_{SR} is stored in secured database 102 in process 610 and selectively replicated user data D_{SR} is transmitted to a transactional or second database in process 612.

Next, in process 614 the selectively replicated user data D_{SR} is received by second database 104 and stored as received selectively replicated user data D_{SR} therein. In process 618, at application server 106B, a transaction request requirement for user transaction data D_{TR} is received and/or generated and transmitted to the second database in process 620 to obtain associated and required read only date D_{RO} in support and in response to the transaction data request requirements. The transaction data request D_{TR} is received by the second database 104 in process 616 and second database identifies the selectively replicated data D_{SR} stored therein that is associated with and that will be responsive to the received transaction data request D_{TR}. The second database 104 transmits a read only data D_{RO} response message that is derived from or that is the selectively replicated data D_{SR} to the application server 106 that is in response to the received transaction data request D_{TR} in process 622. The application server receives the read only data D_{RO} from the second database 104 and processes the requesting or initiating transaction within the application server 106 using the received read only data based on the transaction data request D_{TR} in process 626.

The method further includes transmitting a request from the remote application to the transactional database for transactional user data, receiving the request for requested user data from the remote application by the transactional database, and providing at least a portion of the stored selectively replicated user data as the requested user data to the remote application responsive to the received request. In some such embodiment, the process can also include receiving user data from a user over a user application interface and providing the received user data over the write-only data interface so that such is stored as the received user data. The method can also include receiving a request to provide the requested user data from an transactional application and providing the request for requested user data over the read-only interface wherein the receiving the requested user data from the read-only interface and providing the received requested user data as received from the read-only interface to the transactional application responsive to the request for requested user data.

The method 600 as shown in FIG. 6 can similarly be generically described by the following steps for securing data on data network accessible server. The method can include the steps of: a) in an application server, receiving user data from a user over a user application interface, and transmitting the received user data to a first database server; b) in the first database server, receiving user data from the application server, storing the received user data, identifying a subset of received user data as selectively replicated user data, and transmitting the selectively replicated user data to a transactional database server; c) in the transactional database server, receiving the selectively replicated user data, storing the received selectively replicated user data, d) in the application server, receiving a request to provide requested user data from an application server; and transmitting to the transactional database server a request for user data; e) in the transactional database server, receiving the request for user data from the application server; and providing at least a portion of the stored selectively replicated user data to the application server as provided user data; and f) in the application server, receiving the provided user data from the transactional database server; and providing the provided user data as received from the transactional database server to the application server responsive to the request for requested user data.

As addressed above, in some embodiments, the receiving of the user data from the application server is over a write-only data interface with the application server and the receiving of the request for user data from the application server by the transactional database server is over a read-only data interface. As described herein, such differentiation between a write-only interface and a read-only interface is related with the logical providing of data or a data communication interface via a known or unique/proprietary data communication protocol. Such interfaces may be different physical interfaces or may be the same physical data interface, but having a different logical interface to the database systems or applications.

As described in another manner, one embodiment of the above described system and method implemented as a web application can be described. For example, consider any web application in which a consumer signs up for an account and provides a credit card number to receive a service or product. Traditionally, this data is inserted into a database upon submission and the web application has READ/WRITE access to the data. The data is at the mercy of the web application code and the firewall. However, the disclosed system and method can function by the web application receiving the consumer data and inserting it into the secured database 102 with credentials C1, which only has WRITE capability. The necessary non-critical data is immediately replicated to transactional database 104 per the predefined rules. The web application 106 has access to transactional database 104 with credentials C2, but it only has READ access. As such, the secure data written with credentials C1 when the data was entered by the user, is not accessible by use of credentials C2. Only the subset of the data that is selectively replicated to transactional database 104 is accessible by the web application using credentials C2. Web application cannot access user data originally submitted by the user and written with credentials C1. Such non-replicated data is secured from accessing by this web application or any other application that may attempt to gain access to the user data.

### Computer Environment

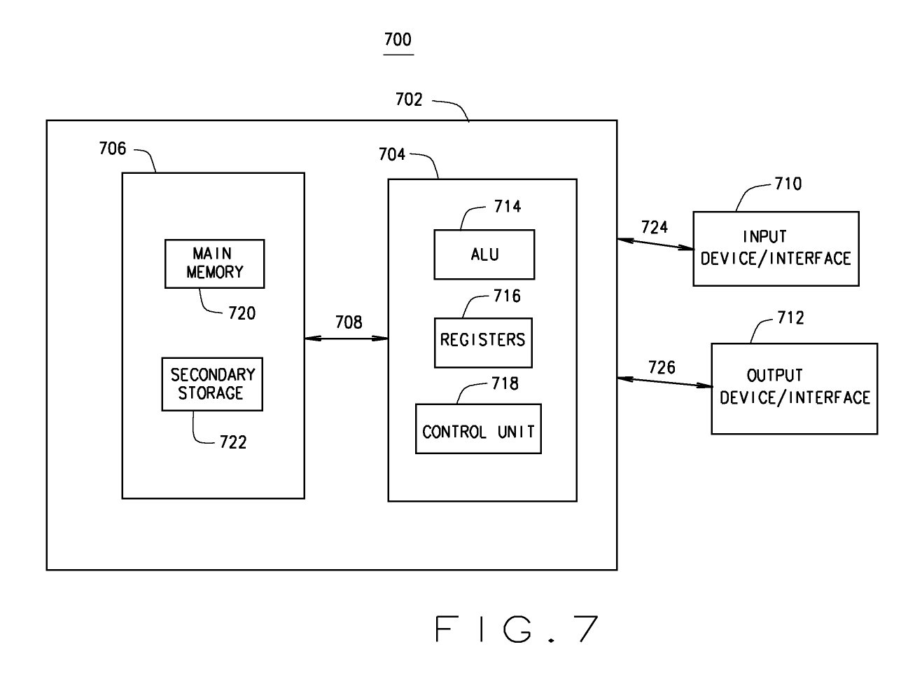

Referring to FIG. 7, an operating environment for an illustrated embodiment of a secured database 102, second database 104, secured application 150, first application server 106A, second or transactional application server 106B can include in one embodiment, one or more computer systems 700 with a computer 702 that comprises at least one high speed processing unit (CPU) 704, in conjunction with a memory system 706 interconnected with at least one bus structure 708, an input device 710, and an output device 712. These elements can be interconnected by at least one bus structure 712.

The illustrated CPU 704 is of familiar design and includes an arithmetic logic unit (ALU) 714 for performing computations, a collection of registers 714 for temporary storage of data and instructions, and a control unit 716 for controlling operation of the system 700. Any of a variety of processors, including at least those from Digital Equipment, Sun, MIPS, Motorola, NEC, Intel, Cyrix, AMD, HP, and Nexgen, are equally preferred for the CPU 704. The illustrated exemplary embodiment operates on an operating system designed to be portable to any of these processing platforms.

The memory system 706 generally includes high-speed main memory 720 in the form of a medium such as random access memory (RAM) and read only memory (ROM) semiconductor devices, and secondary storage 722 in the form of long term storage mediums such as floppy disks, hard disks, tape, CD-ROM, flash memory, etc. and other devices that store data using electrical, magnetic, optical or other recording media. The main memory 720 also can include video display memory for displaying images through a display device. Those skilled in the art will recognize that the memory system 706 can comprise a variety of alternative components having a variety of storage capacities.

The input device 710 and output device 712 are also familiar. The input device 710 can comprise a keyboard, a mouse, a physical transducer (e.g. a microphone), etc. and is interconnected to the computer 702 via an input interface 724. The output device 712 can comprise a display, a printer, a transducer (e.g. a speaker), etc., and be interconnected to the computer 702 via an output interface 726. Some devices, such as a network adapter or a modem, can be used as input and/or output devices.

As is familiar to those skilled in the art, the computer system 700 further includes an operating system and at least one application program. The operating system is the set of software which controls the computer system's operation and the allocation of resources. The application program is the set of software that performs a task desired by the user, using computer resources made available through the operating system. Both are resident in the illustrated memory system 706.

In accordance with the practices of persons skilled in the art of computer programming, the present disclosure is described below with reference to symbolic representations of operations that are performed by the computer system 700. Such operations are sometimes referred to as being computer-executed. It will be appreciated that the operations which are symbolically represented include the manipulation by the CPU 704 of electrical signals representing data bits and the maintenance of data bits at memory locations in the memory system 706, as well as other processing of signals. The memory locations where data bits are maintained are physical locations that have particular electrical, magnetic, or optical properties corresponding to the data bits. The system or components thereof as described herein can be implemented in a program or programs, comprising a series of instructions stored on a computer-readable medium. The computer-readable medium can be any of the devices, or a combination of the devices, described above in connection with the memory system 706.

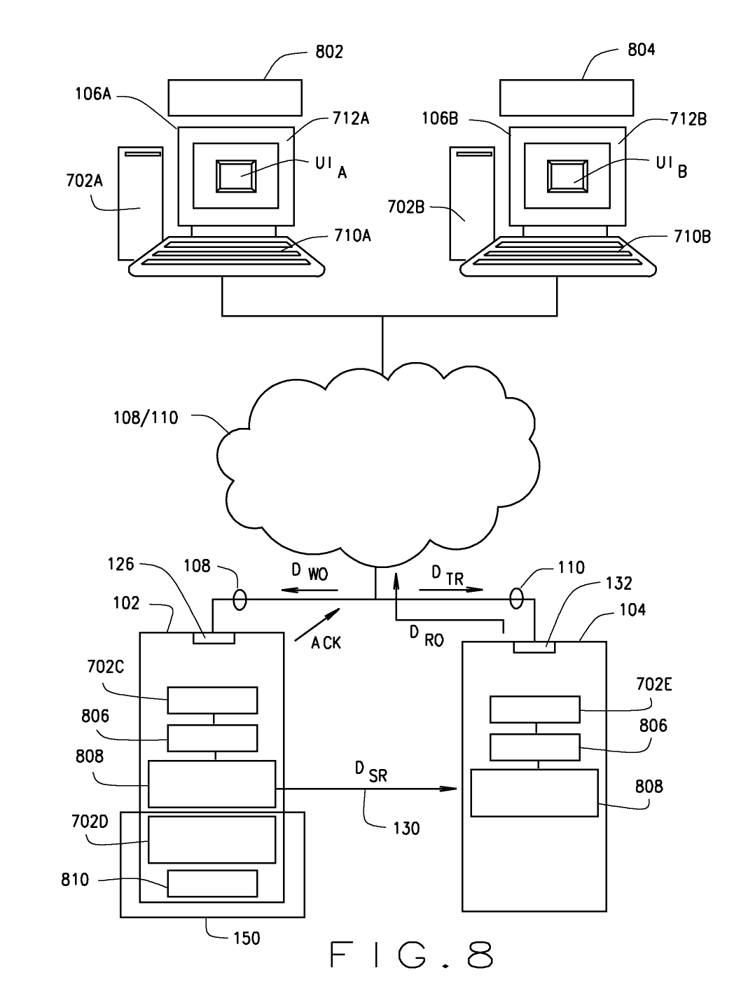

Referring now to FIG. 8 is a further expansion of a computer implemented system according to the various embodiments described herein. As shown here, two application servers 106A and 106B are coupled to the first/secured database 102 and the second transactional database 104 via a cloud network or internet data links 108/110. The first application server 106A is a client device or system 802 that comprises a display 712A with a user interface UI_{A}, an input device 710A and a computer 702A as described in above with regard to FIG. 7. Similarly, a second application or transactional server 106B is a client device or system 804 that comprises a display 712B with a user interface UI_{B}, an input device 710B and a computer 702B as described in above with regard to FIG. 7. The first/secured database system 102 can be coupled to the network data link 108 as a write only interface to computer 702 for receiving write only data D_{WO}. The secured database 102 has a computer 702C configured or programmed with computer executable instructions for a database 808 for storing the received write only data D_{WO} and an application program 808 in support thereof and for selectively identifying replicated or duplicate data D_{SR} that can also be stored and also transmitted to the second database 104 via data link 130. The second database 104 receives the selectively replicated data D_{SR} via data link 130 and stores it in the computer 702E. The secured database 102 can also include a secure application server 150 that includes computer 702E along with application program instructions 810.

The second or transactional application server 106B includes a display 712B that hosts the user interface UI_{B} and has user input device 710B and computer 702B. The transactional server 106 initiates the request for transactional data D_{TR}. The second database 102 receives the data request D_{TR} from data link 110 at interface 132 as a read only request. The second database 104 identifies the stored selectively replicated data D_{SR} that is in database 806 using transaction processing programming instructions 808 to that is associated with or responsive to the received data request D_{TR}. The second database then transmits the read only data D_{RO} based on the identified selectively replicated data D_{SR} that is responsive to the transaction request D_{TR}.

The system and method describe above and in the Figures focuses the strengths of segregated privilege user controls and the replication of non-critical data and removes direct data access. The system and method hereof is completely different and not addressed or developed by previously developed systems and database applications as their focus has been on development of complex database firewalls with encryption and privileged user controls inside the databases and reliance upon secure web application development coding practices.

The system and method described herein allows for the limited transactional application required credentials to be obtained by a legitimate application such as a transactional system or by a hacker or other improper data access attempts to obtain stored secured user data. The present system and method enables transaction processing and replies to data request in support thereof (or the spoofing thereof) in a manner that protects critical data and prevents the exposure of the intruding or potentially unsafe request such as from a hacker and by limiting replies to such efforts to only non-critical data. All of this is performed without the need for reliance on complex encryption, privileged user controls, secured communication links and/or secure web application coding practices. As such, the present system and method provides a significant improvement over prior systems and will provide a significant additional capability for securing critical data.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A system for securing data on a data network accessible server, the system comprising:
a first database server having a processor, a memory, a data network accessible interface configured for receiving user data, having computer executable instructions for a write only database for storing the received user data and identifying a subset of received user data to be provided as selectively replicated user data, and a secured database interface for providing the identified subset of the received user data as selectively replicated user data;
a second database server having a processor, a secured database interface communicatively coupled to the secured database interface of the first database server and receiving the selectively replicated user data, a memory for storing the received selectively replicated user data, and a data network accessible interface configured for receiving a request to provide requested user data and providing provided user data that includes at least a portion of the stored selectively replicated user data; and
an application server having a processor, memory, a user application interface for receiving user data from a user, a third party application interface for receiving a request for certain user data, and a database server interface communicatively coupled to the data network accessible interface of the first database server and the data network accessible interface of the second database server, the application server configured with computer executable instructions receiving the user data over the user application interface, transmitting the receiver user data over the database server interface to the first database server, receiving a third party request for the certain user data over the third party application interface, transmitting the request to provide requested user data to the second database server for the certain user data over the database server interface to the second database server, receiving from the second database server the provided user data, and providing over the third party application interface a response to the third party request that includes the received provided user data.

2. The system of claim 1 wherein the first database server and the second database server are separate database servers having separate processors, memories, data network accessible interfaces and communicatively coupled secured database interfaces.

3. The system of claim 1 wherein the first database server and the second database server are the same database server.

4. The system of claim 1 wherein the application server is a web hosting server and the third party application is a hosted web application.

5. The system of claim 4 wherein user interface is a user interface to the hosted web application, and wherein the received user data includes first user data and second user data, the first user data being non-critical user data such as user identification, name or application or transactional name or identification, and the second user data being critical user data including social security numbers, and/or credit card numbers.

6. The system of claim 5 wherein identified subset of received user data includes the first use data and at least one of a selected subset of the second user data and derived secured data derived from a portion of the second user data.

7. The system of claim 6 wherein the at least one of a selected subset of the second user data and derived secured data derived from a portion of the second user data includes at least one of the last four digits of a social security number or the last four digits of a credit card number.

8. The system of claim 6 wherein selectively replicated user data excludes one or more data selected from the group consisting of a full social security number, a full credit card number, a card security CVV code, a full pin number, and a full user account number.

9. The system of claim 6 wherein the selectively replicated user data includes only a subset of a data type selected from the group consisting of a full social security number, a full credit card number, a card security CVV code, a full pin number, and a full user account number.

10. The system of claim 1 wherein identified subset of received user data includes the first use data and at least one of a selected subset of the second user data and derived secured data derived from a portion of the second user data.

11. The system of claim 1 wherein the at least one of a selected subset of the second user data and derived secured data derived from a portion of the second user data includes at least one of the last four digits of a social security number or the last four digits of a credit card number.

12. The system of claim 1 wherein selectively replicated user data excludes a data type selected from the group consisting of a full social security number, a full credit card number, a card security CVV code, a full pin number, and a full user account number.

13. The system of claim 1 wherein the selectively replicated user data includes a data type selected from the group consisting of a full social security number, a full credit card number, a card security CVV code, a full pin number, and a full user account number.

14. The system of claim 1 wherein the third party or application server is a transactional processing system and wherein the request for certain user data is a transaction processing request.

15. The system of claim 1 wherein the first database server and/or the data network accessible interface of the first database server is configured as a write-only interface and is configured to not respond to any data read requests from the application server over the first database server data network accessible interface.

16. The system of claim 1 wherein the second database server and/or the data network accessible interface of the second database server is configured as a read-only interface and is configured to not respond to any data write requests from the application server over the first database server data network accessible interface.

17. A system for securing data on data network accessible server, the system comprising:
a first database server having a data network accessible interface configured for receiving user data, storing the received user data, and identifying a subset of received user data to be provided as selectively replicated user data, and a secured database interface for providing the identified subset of the received user data as selectively replicated user data;
a second database server having a secured database interface communicatively coupled to the secured database interface of the first database server and receiving the selectively replicated user data, storing the received selectively replicated user data, and a data network accessible interface for receiving a request to provide requested user data and providing provided user data that includes at least a portion of the stored selectively replicated user data; and
an application server having configured for receiving user data from a user, receiving the user data over the user application interface, transmitting the receiver user data over the database server interface to the first database server, receiving a request for the certain user data, transmitting the request for user data to the second database server, receiving from the second database server the provided user data, and providing the provided user data as received from the second database server.

18. The system of claim 17 wherein the first database server and/or the data network accessible interface of the first database server is configured as a write-only interface and is configured to not respond to any data read requests from the application server over the first database server data network accessible interface.

19. The system of claim 17 wherein the second database server and/or the data network accessible interface of the second database server is configured as a read-only interface and is configured to not respond to any data write requests from the application server over the first database server data network accessible interface.

20. A system for securing data on data network accessible server, the system comprising:
a secure data application including a first database and a first data interface for receiving user data and storing the received user data, the application configured for identifying a subset of received user data as selectively replicated user data, and a secured database interface for providing the identified selectively replicated user data to a second database; and
the second database having a secured database interface communicatively coupled to the secured database interface of the secure data application and receiving the selectively replicated user data, storing the received selectively replicated user data, the second database having a data request interface for receiving a request to provide requested user data, the second database configured to provide at least a portion of the stored selectively replicated user data in response as the requested user data in response to the request thereof.

21. The system of claim 20 wherein the data interface of the secure data application first database is configured as a write-only interface and is configured to not provide a response or provide any data responsive to any data read requests.

22. The system of claim 20 wherein the second database and the data interface of the second database are configured as a read-only interface and is configured to not respond to any data write requests but only provide at least a portion of the stored selectively replicated user data.

23. The system of claim 20, further comprising:
a transactional application configured for receiving user data from a user over a user application interface, transmitting the receiver user data over a first database interface to the secure database application, receiving a request that includes the certain user data, transmitting the request for the certain user data to the second database, receiving from the second database the provided certain user data, and providing the provided certain user data as received from the second database responsive to the received request thereof.

24. The system of claim 23 wherein the transactional application is a computer implemented application on a transaction processing system for processing user related transactions.

25. The system of claim 24 wherein the transaction processing system is communicatively coupled to the secure database application over a data network.

26. The system of claim 23 wherein the transactional application includes a hosted web-based user interface for receiving the user data from the user.

27. The system of claim 26 wherein the hosted web-based user interface receives user data including first user data and second user data, the first user data being non-critical user data and the second user data being critical user data.

28. The system of claim 27 wherein the non-critical user data includes a data type selected from the group consisting of a user identification, a name, an application, a transactional name, and an identification, and the second user data is a data type selected from the group consisting of a social security number, an account number, a credit card number, a personal identification number, a password, and a security code.

29. The system of claim 26 wherein identifying the subset of received user data includes the first use data and at least one of a) a selected subset of the second user data and b) derived secured data derived from a portion of the second user data.

30. The system of claim 20 wherein the at least one of a selected subset of the second user data and derived secured data derived from a portion of the second user data includes at least one of the last four digits of a social security number or the last four digits of a credit card number.

31. The system of claim 20 wherein selectively replicated user data excludes a data type selected from the group consisting of a full social security number, a full credit card number, a card security CVV code, a full pin number, and a full user account number.

32. The system of claim 20 wherein the selectively replicated user data includes only a subset of a data type selected from the group consisting of a full social security number, a full credit card number, a card security CVV code, a full pin number, and a full user account number.

33. The system of claim 20 wherein the secure data application and the second database are implemented on separate servers having separate processors, memories, data network accessible interfaces and communicatively coupled secured database interfaces.

34. The system of claim 20 wherein the secure data application and the second database are implemented on the same database server.

35. A method for securing data on data network accessible server, the method comprising:
a. in an application server:
receiving user data from a user over a user application interface, and
transmitting the received user data to a first database server;
b. in the first database server:
receiving user data from the application server,
storing the received user data,
identifying a subset of received user data as selectively replicated user data, and
transmitting the selectively replicated user data to a second database server;
c. in the second database server:
receiving the selectively replicated user data;
storing the received selectively replicated user data;
d. in the application server:
receiving a request to provide requested user data from an application server; and
transmitting to the second database server a request for user data;
e. in the second database server:
receiving the request for user data from the application server; and
providing at least a portion of the stored selectively replicated user data to the application server as provided user data;
f. in the application server:
receiving the provided user data from the second database server; and
providing the provided user data as received from the second database server to the application server responsive to the request for requested user data.

36. The method of claim 35 wherein receiving the user data from the application server is over a write-only data interface with the application server and wherein receiving the request for user data from the application server by the second database server is over a read-only data interface.

37. The method of claim 35 wherein the first database server and the second database server are the same database server.

38. A method for securing data on data network accessible server, the method comprising:
receiving user data in a first database from an remote application,
storing the received user data,
identifying a subset of received user data as selectively replicated user data, and
transmitting the selectively replicated user data to a second database;
receiving in the second database the selectively replicated user data,
storing the received selectively replicated user data,
transmitting a request from the remote application to the second database for transactional user data;
receiving the request for requested user data from the remote application by the second database; and
providing at least a portion of the stored selectively replicated user data as the requested user data to the remote application responsive to the received request.

39. A method for securing data on data network accessible server, the method comprising:
receiving user data from a remote application over a write-only data interface;
storing the received user data in a first database;
identifying in the first database a subset of received user data as selectively replicated user data;
transmitting the identified selectively replicated user data over a secured data interface;
receiving the transmitted selectively replicated user data over a communicatively coupled second secured data interface;
storing the received selectively replicated user data in a second database;
receiving a request for requested user data from a remote application at the second database over a read-only data interface; and
transmitting at least a portion of the stored selectively replicated user data as the requested user data responsive to the received request.

40. The method of claim 39, further comprising:
receiving user data from a user over a user application interface;
providing the received user data over the write-only data interface;
receiving a request to provide the requested user data from an transactional application;
providing the request for requested user data over the read-only interface receiving the requested user data from the read-only interface; and
providing the received requested user data as received from the read-only interface to the transactional application responsive to the request for requested user data.
